(19) United States
(12) Patent Application Publication
(10) Pub. No.: US 2013/0213724 A1
(43) Pub. Date: Aug. 22, 2013

(54) ELECTROLYSIS SYSTEM FOR HYDROGEN AND OXYGEN PRODUCTION

(71) Applicant: Charles Robert Storey, Clarington, OH (US)

(72) Inventor: Charles Robert Storey, Clarington, OH (US)

(21) Appl. No.: 13/846,049

(22) Filed: Mar. 18, 2013

Related U.S. Application Data
(63) Continuation of application No. 12/372,772, filed on Feb. 18, 2009, now abandoned.
(60) Provisional application No. 61/188,092, filed on Aug. 7, 2008.

(51) Int. Cl. C25B 1/02; B60K 15/10

(52) U.S. Cl. CPC C25B 1/02; B60K 15/10
USPC 180/69.5; 204/242; 204/275.1; 204/278

(57) ABSTRACT

An electrolysis system adapted to split water into hydrogen and oxygen gases includes a housing, a baffle dividing the housing into first and second chambers and including an upper solid portion and a lower portion, a first electrode disposed in the first chamber, and a second electrode disposed in the second chamber. The first and second electrodes are configured to be at least partially immersed in the water, and each electrode becomes electrically charged when the electrolysis system is coupled to a current source to split the water into hydrogen and oxygen gases. The lower portion of the baffle and the first and second electrodes are each formed from the same material.

### CROSS-REFERENCE TO RELATED APPLICATIONS

This application is a continuation of U.S. patent application Ser. No. 12/372,772 filed Feb. 18, 2009 (pending) which claims the benefit of U.S. Provisional Patent Application Ser. No. 61/188,092, filed Aug. 7, 2008 (expired), the disclosure of which is fully incorporated by reference herein.

### TECHNICAL FIELD

This invention relates to electrolysis systems, and more specifically, to electrolysis systems used alone or in combination with an internal combustion engine of a vehicle.

### BACKGROUND

Energy costs have been rising worldwide as gasoline demand skyrockets. A primary consumer of gasoline, vehicles have been running with a traditional internal combustion engine for many decades. Internal combustion engines combine gasoline with air received through an engine intake and ignites the mixture within a combustion chamber to produce power or mechanical driving motion. As more cars are driven throughout the world, the strain on non-renewable oil and gasoline supplies has increased, contributing to the rising costs. In order to limit fuel costs and sustain the vehicle business, manufacturers have recently turned to alternative sources of power, such as electricity, ethanol, etc. One of the more promising ideas is operating an internal combustion engine on hydrogen gas, which is combustible in a similar fashion as gasoline. Furthermore, hydrogen gas may be created by splitting water molecules in a process called electrolysis. Consequently, hydrogen gas is a desirable renewable energy substitute for the conventional internal combustion engine.

The use of hydrogen gas for combustion in an engine is well known. However, tanks of hydrogen gas are currently very expensive to buy for use in an internal combustion engine and the tanks of hydrogen gas must be carried somewhere on the vehicle, which poses a serious threat to the occupants of the vehicle when an accident occurs. Hydrogen gas is much more volatile and subject to explosion as compared to regular gasoline. Furthermore, hydrogen gas tanks are maintained at high internal pressures, which leads to a higher explosion risk. Due to these factors, one design challenge is to form a tank from a suitable material so as to minimize the weight to the vehicle, and yet maximize the protection to its occupants from a hydrogen tank explosion in an accident. No reasonably priced tank materials have been discovered which would lower the safety risk of the hydrogen tank exploding in a crash to an acceptable minimum. These safety concerns have stunted the development of vehicle engines that run partially or completely on hydrogen gas instead of gasoline.

In order to overcome these concerns, vehicle manufacturers have turned to electrolysis to form hydrogen and oxygen in a continuous manner and to feed the internal combustion engine these substitutes for gasoline and air. Electrolysis is the splitting of water molecules with electricity to form hydrogen gas and oxygen gas. Using an electrolysis device in combination with an internal combustion engine is also well known in the art. However, current electrolysis systems continue to have numerous drawbacks. One limitation is the rapid corrosion of the electrodes used in the electrolysis device. Another problem is the low efficiency of converting electricity to hydrogen and oxygen in current electrolysis systems, which leads to increased use of gasoline in hybrid internal combustion engines that burn hydrogen and gasoline. With these drawbacks, the overall operating costs of engines incorporating these prior electrolysis systems rival the costs of their gasoline-only counterparts. Thus, these electrolysis systems have not been universally implemented in the vehicle industry. It would be desirable to improve on the inefficient prior art electrolysis systems designed for use in vehicles.

### SUMMARY

To overcome these and other problems, an electrolysis system for splitting water into hydrogen and oxygen gases includes a housing, a baffle, a first electrode, and a second electrode. The baffle divides the housing into a first chamber and a second chamber. The baffle includes an upper solid portion and a lower portion allowing fluid communication between the chambers. The first electrode is disposed in the first chamber, and the second electrode is disposed in the second chamber. Each electrode is configured to be at least partially immersed in the water. The lower portion of the baffle and each of the first and second electrodes are formed from the same material. When the electrolysis system is coupled to a current source, the first and second electrodes become electrically charged so as to split the water into hydrogen and oxygen gases.

The electrolysis system may further include a horizontal barrier wall dividing the housing into an upper compartment and a lower compartment. The upper and lower compartments are fluidly isolated from each other. The upper compartment contains an inlet port adapted to deliver water from outside the housing to the lower compartment, while the lower compartment contains the baffle and the first and second chambers. The electrolysis system may further include a first fastener member coupling the first electrode to the horizontal barrier wall and a second fastener member coupling the second electrode to the horizontal barrier wall. A positive lead wire may enter the housing at the upper compartment to be coupled with the first fastener member. A negative lead wire may enter the housing at the upper compartment to be coupled with the second fastener member. The positive and negative lead wires may be coupled to a vehicle's electrical supply.

The material forming the lower portion of the baffle and the first and second electrodes may be formed from mesh screen material. The mesh screen material may be formed from stainless steel. The second electrode may include a plurality of wire fingers extending away from the mesh screen material. The second electrode may further include a perimeter edge, and the wire fingers may include frayed ends of the mesh screen material along this perimeter edge.

### BRIEF DESCRIPTION OF THE DRAWINGS

FIG. 1 is a perspective view of an automobile with part of the hood cut away showing an internal combustion engine and an electrolysis system according to one embodiment of the invention.

FIG. 2 is a perspective view of the electrolysis system of FIG. 1.

FIG. 3 is a cross-sectional side view of the electrolysis system of FIG. 1.

FIG. 4 is a cross-sectional top view of the electrolysis system of FIG. 1, taken through the upper compartment of the electrolysis system.

FIG. 5A is a cross-sectional front view of the electrolysis system of FIG. 1, taken through the second chamber of the lower compartment of the electrolysis system.

FIG. 5B is a cross-sectional front view of the electrolysis system of FIG. 1, taken through the first chamber of the lower compartment of the electrolysis system.

FIG. 5C is a cross-sectional side view of the electrolysis system of FIG. 1, illustrating the inlet port.

FIG. 5D is a cross-sectional side view of the electrolysis system of FIG. 1, illustrating the oxygen outlet port.

FIG. 5E is a cross-sectional side view of the electrolysis system of FIG. 1, illustrating the hydrogen outlet port.

FIG. 6 is a cross-sectional side view of an alternative embodiment of an electrolysis system with a combined outlet port.

FIG. 7 is a perspective view of an electrode of the electrolysis system of FIG. 1.

### DETAILED DESCRIPTION

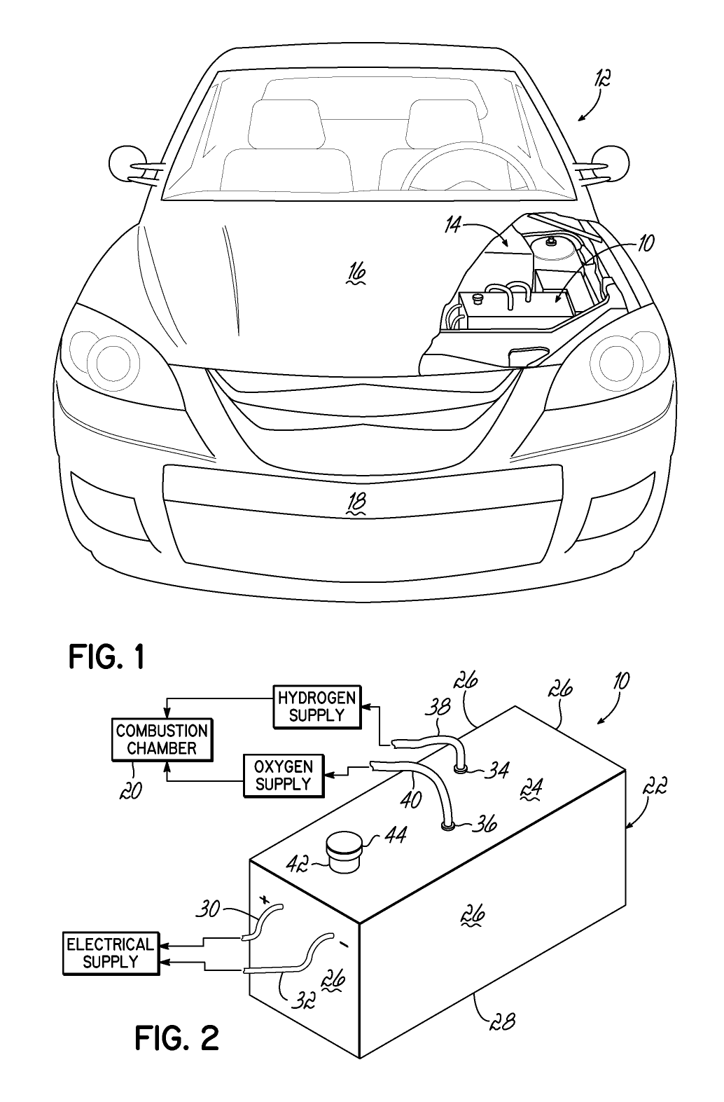

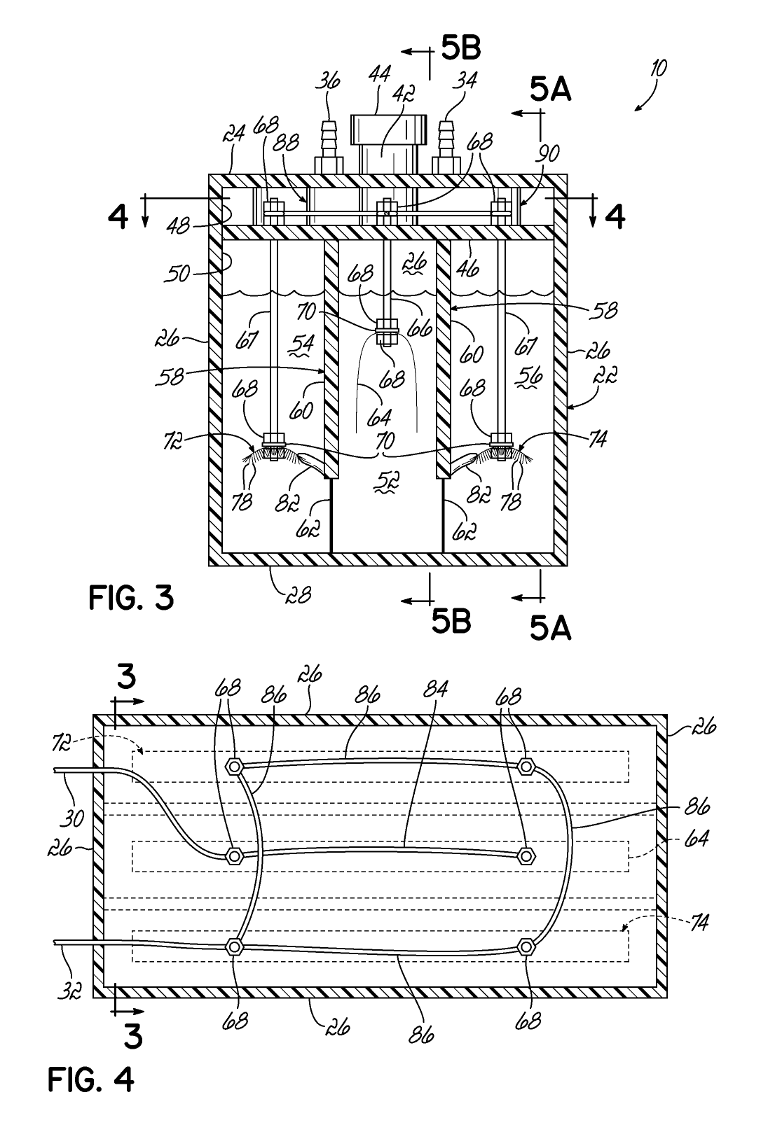

FIG. 1 illustrates one embodiment of an electrolysis system 10 mounted within a vehicle. The vehicle illustrated in FIG. 1 is a passenger automobile 12, but one skilled in the art will appreciate that the electrolysis system 10 can be implemented with other vehicles, such as tractors, trains, etc. The automobile 12 typically has an internal combustion engine 14 located within an engine compartment located under a hood 16 at the front end 18 of the automobile 12. The electrolysis system 10 may be positioned securely within the engine compartment and is adapted to provide hydrogen gas and oxygen gas to the combustion chamber 20 (shown schematically in FIG. 2) of the engine 14. The hydrogen gas is highly combustible when mixed with the oxygen gas, allowing the engine 14 to create driving power to move the automobile 12. In one embodiment, the internal combustion engine 14 of FIG. 1 includes a bracket (not shown) in an open space or recess adapted to snugly position the electrolysis system 10 near the front end 18 of the automobile 12. Locating the electrolysis system 10 near the front end 18 allows for easy operator access to the electrolysis system 10, which may be advantageous as explained below. Alternatively, the electrolysis system 10 may be mounted at other locations throughout the automobile 12, as the hydrogen and oxygen gases may be piped from these other locations through conduits to the engine intake.

In one embodiment, the hydrogen and oxygen gases are delivered through the engine intake to be mixed with gasoline. The hydrogen may then be combusted in combination with the gasoline. In this embodiment, it is believed the gasoline consumption of the engine can be reduced by up to 50% or more when supplemented with hydrogen and oxygen from electrolysis system 10. In an alternative embodiment, the hydrogen gas supplied by the electrolysis system 10 may completely replace all gasoline consumption in the engine 14. The engine 14 of this alternative embodiment may include an upper-cylinder lubrication system and an oil drier for removing water from the engine 14 that forms upon combustion of hydrogen and oxygen (not shown). Although the remainder of this description will focus on the embodiment where hydrogen gas is used in combination with gasoline, one skilled in the art will appreciate that the invention is not limited to this embodiment.

An exemplary embodiment of the electrolysis system 10 is illustrated in FIG. 2. The electrolysis system 10 includes a generally rectangular housing 22 including a top wall 24, a plurality of sidewalls 26, and a bottom wall 28. The housing 22 may be formed from suitable engineering materials, such as thermoplastic material. In one embodiment, the housing 22 may be formed from Plexiglass panels of a standard thickness (e.g., ⅜″ thick). This Plexiglass material may allow the housing 22 to be transparent or opaque depending on the preferences of the consumer. The walls 24, 26, 28 may be coupled to each other using an adhesive material. For example, one appropriate adhesive material is Plastic Weld® made by Devcon Corporation in Danver, Mass. Alternatively, the walls 24, 26, 28 may be formed integrally with each other. For example, the walls 24, 26, 28 may be formed as a one-piece construction in an injection molding process. One skilled in the art will recognize that the formation of the housing 22 is not limited to any one particular process.

A positive lead wire 30 extends from a sidewall 26 to a positively-charged voltage source such as the fusebox (not shown) of the automobile 12. A negative lead wire 32 extends from the sidewall 26 to electrical ground through the vehicle chassis. As is generally understood in the art, electric current traveling through the lead wires 30, 32 is capable of splitting water into hydrogen and oxygen gas within the electrolysis system 10. The hydrogen gas exits the housing 22 through hydrogen outlet nozzle 34, and the oxygen gas exits the housing 22 through oxygen outlet nozzle 36. The hydrogen outlet nozzle 34 and oxygen outlet nozzle 36 may be coupled to first and second conduits 38, 40 (e.g., flexible hoses), respectively, which deliver the hydrogen and oxygen gas from the electrolysis system 10 to the combustion chamber 20 of engine 14. The housing 22 also includes an inlet port 42 adapted to receive water for the electrolysis process. The inlet port 42 includes a plug 44 adapted to prevent the escape of hydrogen and oxygen gas during operation of the electrolysis system 10. The plug 44 also prevents the water contained in the housing 22 from escaping through inlet port 42.

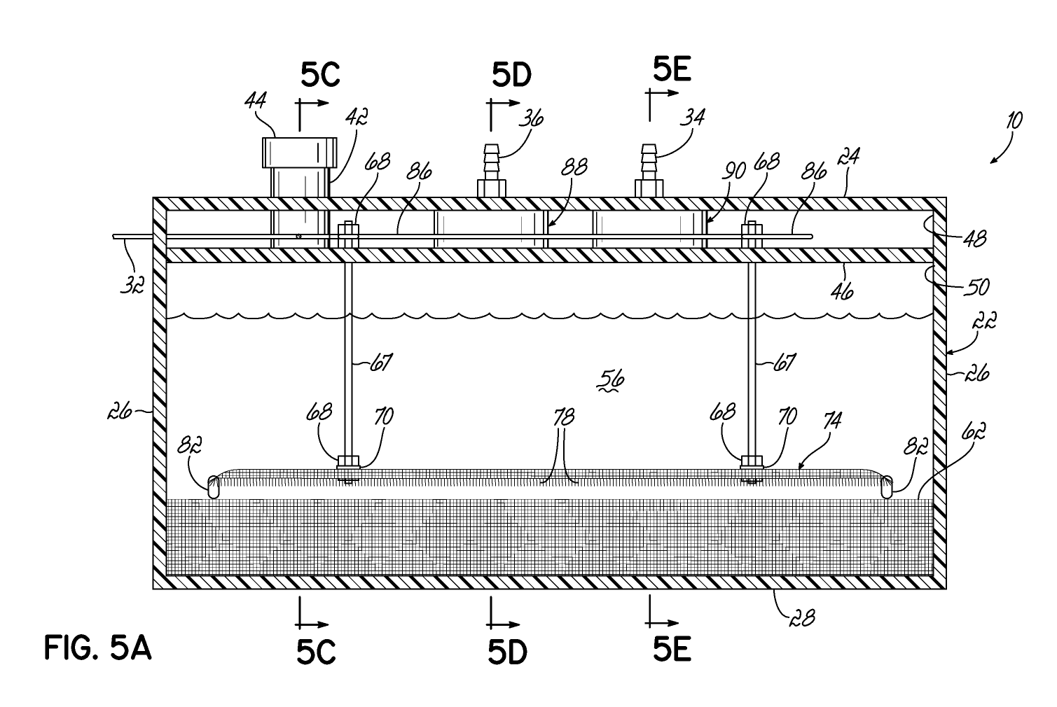

One embodiment of the electrolysis system 10 is shown in further detail in FIGS. 3-5E. The electrolysis system 10 further includes a horizontal barrier wall 46 coupled to the sidewalls 26 adjacent but spaced from the top wall 24 of the housing 22. The horizontal barrier wall 46 may be adhesively coupled to the sidewalls 26. One skilled in the art will appreciate that the horizontal barrier wall 46 could be coupled to the sidewalls 26 in an alternative manner, including being integrally formed with the sidewalls 26. The horizontal barrier wall 46 divides the housing 22 into an upper compartment 48 and a lower compartment 50. The upper compartment 48 is fluidly isolated from the lower compartment 50. The lower compartment 50 is further divided into a first chamber 52, a second chamber 54, and a third chamber 56 by a pair of baffles 58 extending from the bottom wall 28 to the horizontal barrier wall 46. The pair of baffles 58 includes an upper solid portion 60 and a lower portion 62. The lower portion 62 is configured to provide fluid communication between the chambers. In one embodiment, the horizontal barrier wall 46 and the upper solid portions 60 of the baffles 58 may be formed from thermoplastic material (e.g., ⅜″ thick Plexiglass). The horizontal barrier wall 46 and the upper solid portions 60 of the baffles 58 may be integrally formed or may be coupled to each other. For example, the horizontal barrier wall 46 and the baffles 58 could be coupled with an adhesive material, such as Plastic Weld®.

In one exemplary embodiment, the lower portion 62 of the baffles 58 may be formed from mesh screen material. Moreover, the mesh screen material may be formed from stainless steel, nickel, or other suitable materials as recognized by those of ordinary skill in the art. In one embodiment, the mesh screen material may be formed with between approximately 30 to approximately 60 openings or wires per inch of mesh. In a preferred embodiment, the mesh screen material is formed from approximately 42 mesh/inch screen material. The first chamber 52 is disposed between the second chamber 54 and the third chamber 56, and is in fluid communication with the second chamber 54 and the third chamber 56 through the openings in lower portions 62 of the baffles 58.

The electrolysis system 10 includes a first electrode 64 disposed in the first chamber 52 and configured to be at least partially immersed in the water. The first electrode 64 may be formed from the same material as the lower portion 62 of the baffles 58. Thus, in the embodiment shown in FIGS. 3-5E, the first electrode 64 may be formed from approximately 42 mesh/inch stainless steel screen material. One skilled in the art will understand that alternative screen materials and more or fewer openings per inch may be used to form the first electrode 64. The first electrode 64 may be folded into a downward-facing U-shape and includes at least one aperture (not shown) adapted to receive a first threaded fastener 66. For example, the first threaded fastener 66 may be a stainless steel bolt which extends through the horizontal barrier wall 46. Locking nuts 68 and washers 70 may couple the first threaded fastener 66 to the horizontal barrier wall 46 and the first electrode 64, thereby maintaining the position of the first electrode 64 within the first chamber 52.

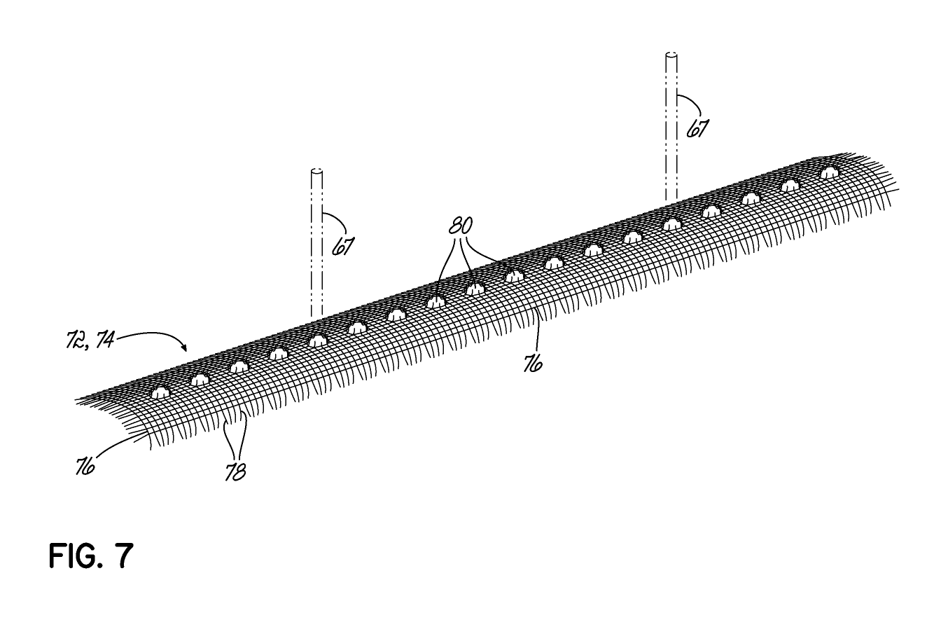

The electrolysis system 10 also includes a second electrode 72 disposed in the second chamber 54 and a third electrode 74 disposed in the third chamber 56, the second electrode 72 and the third electrode 74 each configured to be at least partially immersed in the water. In one embodiment, the second and third electrodes 72, 74 may be formed from the same material as the lower portion 62 of the baffles 58. As illustrated more clearly in FIG. 7, the second and third electrodes 72, 74 may be formed from generally rectangular pieces of approximately 42 mesh/inch stainless steel screen material. One skilled in the art will appreciate that alternative screen materials and more or fewer openings per inch may be used to form the second electrode 72 and the third electrode 74.

In one aspect in accordance with embodiments of the invention, the perimeter edge 76 of the mesh screen material may be frayed such that a plurality of wire fingers 78 extends away from the perimeter edge 76 of the second and third electrodes 72, 74. In a preferred example, approximately ⅜″ of the mesh screen material is stripped out along the perimeter edge 76 to form approximately ⅜″ long wire fingers 78. Thus, the wire fingers 78 are frayed ends integral with the mesh screen material and help increase the effective surface area of the second and third electrodes 72, 74. It is also believed that the wire fingers 78 increase the efficiency of hydrogen and oxygen gas generation during the electrolysis process. The second and third electrodes 72, 74 each include at least one aperture 80 through the screen material. Similar to the first electrode 64, a second threaded fastener 67 extends through the aperture 80 and is coupled to the horizontal barrier wall 46 and one of the second or third electrodes 72, 74 with locking nuts 68 and washers 70. At least one insulated support member 82 extends away from the baffles 58 to engage the second and third electrodes 72, 74 and to help secure the second and third electrodes 72, 74 in the second and third chambers 54, 56, respectively.

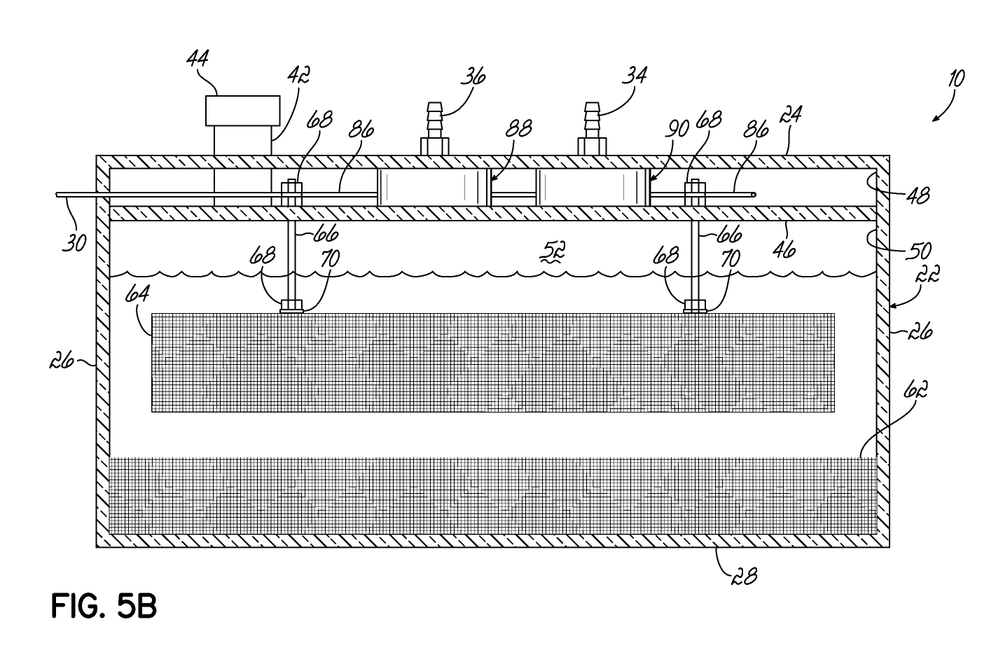

The upper compartment 48 includes electrical wiring as shown in FIG. 4. The positive lead wire 30 extending through the side wall 26 may be spliced to a secondary positive wire 84 connected to the first threaded fastener 66 such that the first electrode 64 becomes positively charged. The negative lead wire 32 extending through the side wall 26 may be spliced to a plurality of secondary negative wires 86 connected to the second threaded fasteners 67 such that the second and third electrodes 72, 74 become negatively charged. As is known in the art of electrolysis, when an active voltage source is connected to the lead wires 30, 32, electrical current will flow through the positively-charged first electrode 64 and through the water in the housing 22 to the negatively-charged second and third electrodes 72, 74.

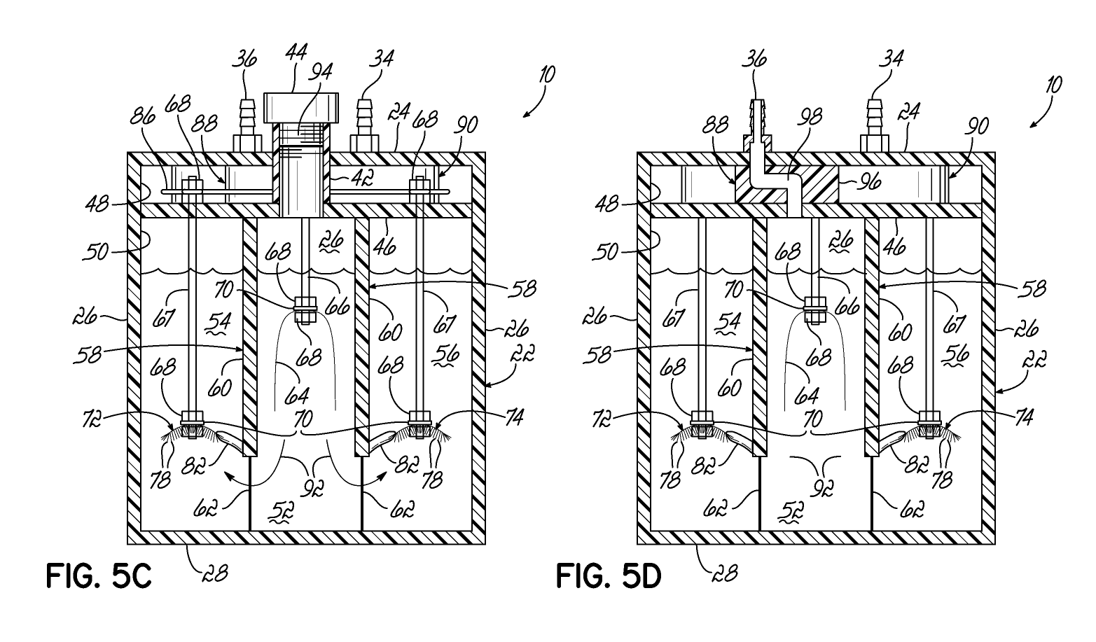

As more clearly illustrated in FIGS. 5A-5B, the upper compartment 48 also includes the inlet port 42, an oxygen port 88, and a hydrogen port 90. As described above and shown in FIG. 5C, the inlet port 42 extends through the upper compartment 48 to allow water to be poured into the housing 22 from the outside environment. The water enters the first chamber 52 of the lower compartment 50 but also fills the second and third chambers 54, 56 through the lower portion 62 of the baffles 58 as indicated by arrows 92. The plug 44 may include external threads 94 which mate with internal threads in the inlet port 42 to close the inlet port 42. As shown in FIG. 5D, the oxygen port 88 may include a manifold 96 defining a passage 98 between the first chamber 52 and the oxygen outlet nozzle 36. As shown in FIG. 5E, the hydrogen port 90 may include a manifold 100 defining a passage 102 between the second and third chambers 54, 56 and the hydrogen outlet nozzle 34.

To operate the electrolysis system 10, water is poured into the inlet port 42 until the lower compartment 50 is nearly full. In one embodiment, the water used in the electrolysis system 10 may be distilled water with an electrolyte added. The electrolyte (e.g., sodium chloride) raises the electrical conductivity of the distilled water significantly. One preferred mixture used in the electrolysis system 10 is one tablespoon of sodium chloride for each gallon of distilled water. In an alternative embodiment, alcohol may also be added to the water and electrolyte mixture to lower the freezing point of the mixture in winter conditions. One skilled in the art will realize that the invention is not limited to the mixture of distilled water and sodium chloride and other liquids and/or electrolytes may be used in electrolysis system 10. As discussed previously, the positive lead wire 30 is coupled to a connector in the automobile's fusebox which can deliver approximately 10 amps of current. In one embodiment, the electrical power required is approximately 5 amps at 12 Volts DC, or about 60 Watts of power. Using this arrangement, electrical current is delivered to the electrolysis system 10 only when the automobile 12 is operating. As such, the electrolysis system 10 only creates the combustible hydrogen and oxygen gases on an as-needed basis, eliminating the need to carry a highly dangerous tank of pressurized hydrogen. Consequently, the low power requirement and as-needed generation of the electrolysis system 10 lowers operating costs relative to conventional electrolysis systems, making the electrolysis system 10 a viable alternative for automobile manufacturers.

As described previously, the electrical current flows through the first electrode 64 through the water and to the second and third electrodes 72, 74. The positive charge of the first electrode 64 causes the oxidation of water molecules to form oxygen gas bubbles on the surface of the first electrode 64. Similarly, the negative charge of the second and third electrodes 72, 74 causes the reduction of water molecules to form hydrogen gas bubbles on the surface of the second and third electrodes 72, 74. As noted above, the plurality of wire fingers 78 on the second and third electrodes 72, 74 improves current flow and hydrogen gas production at those electrodes 72, 74. The oxygen and hydrogen gases then rise or bubble to the surface of the water in the lower compartment 50 and flow through the oxygen port 88 and hydrogen port 90, respectively. As shown in FIG. 2, the first and second conduits 38, 40 deliver the oxygen and hydrogen gases to the engine intake and the combustion chamber 20 of engine 14.

On most automobiles 12, an oxygen sensor will be added to the combustion chamber 20 so that the levels of oxygen and hydrogen entering the engine 14 may be monitored by the on-board computer system of the automobile 12. The computer system may then compensate for the hydrogen gas by lowering the controlled amount of gasoline added to the combustion chamber 20. The hydrogen and oxygen combustion results in the formation of water vapor alone. Consequently, the electrolysis system 10 is substantially pollution-free and reduces the harmful emissions of a gasoline-burning internal combustion engine 14. Over time, a driver will only have to add more water and electrolyte mixture to refill the electrolysis system 10 and continue generating hydrogen and oxygen gases. It is believed that the use of the same material (e.g., stainless steel) to form the lower portion 62 of the baffles 58 and each of the first, second, and third electrodes 64, 72, 74 substantially reduces corrosion of the electrodes over time. This arrangement of baffles 58 and electrodes 64, 72, 74 complements the passing of electrical current through the water, which leads to more electrolyzed water molecules and substantially no corrosion over the typical lifetime of the automobile 12. The substantial reduction of corrosion on the electrodes 64, 72, 74 reduces the operating costs of the electrolysis system 10, further making the electrolysis system 10 a viable alternative to current automobile electrolysis systems.

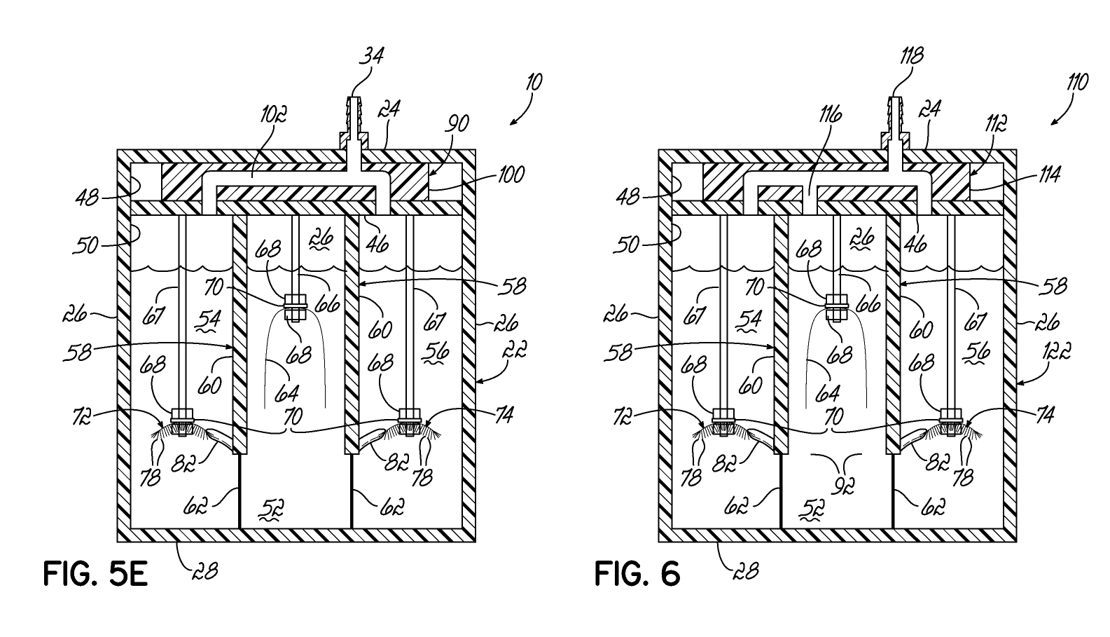

In an alternative embodiment of an electrolysis system 110 illustrated in FIG. 6, the hydrogen port 90 and oxygen port 88 are replaced with a combined port 112. The combined port includes a manifold 114 defining a passage 116 between the first, second, and third chambers 52, 54, 56 and a combined outlet nozzle 118 through the housing 122. This combined outlet nozzle 118 may be connected to a conduit operatively coupled to the combustion chamber 20 of engine 14 as previously described in the first embodiment. A portion of the hydrogen gas and oxygen gas traveling in the passage 116 and conduit will recombine into what is known as Brown's Gas, or commonly ducted oxyhydrogen. It is believed that Brown's Gas may combust with up to 3.8 times as much energy as separately ducted hydrogen gas and oxygen gas. Thus, the electrolysis system 110 of this embodiment may allow for even higher fuel efficiency in the automobile 12.

In alternative embodiments not illustrated, a standard internal combustion engine 14 or the engine compartment may not include a recess for mounting the electrolysis system 10. In these arrangements, the engine 14 may be modified to create a mounting position, or the electrolysis system 10 may be placed in alternative locations of the automobile 12, such as the passenger compartment or the trunk. However, these alternative locations for the electrolysis system 10 may not be as convenient for a driver because the lead wires 30, 32 and first and second conduits 38, 40 still need to be routed from the electrolysis system 10 into the engine 14. Nevertheless, the flexibility of where the electrolysis system 10 can be mounted allows the electrolysis system 10 to be added to or retrofit to nearly any make and model of automobile 12.

While the present invention has been illustrated by a description of preferred embodiments and while these embodiments have been described in some detail, it is not the intention of the Applicant to restrict or in any way limit the scope of the appended claims to such detail. For example, a different style of mesh screen could be used to form the electrodes and lower portion of the baffles. Additional advantages and modifications will readily appear to those skilled in the art. The various features of the invention may be used alone or in any combination depending on the needs and preferences of the user. This has been a description of the present invention, along with the preferred methods of practicing the present invention, as currently known. However, the invention itself should only be defined by the appended claims.

What is claimed is:

1. A vehicle comprising:
a body including at least two wheels;
an internal combustion engine adapted to deliver drive power to move the vehicle; and
an electrolysis system mounted in the body and operatively coupled to the internal combustion engine, the electrolysis system comprising:
a housing including first, second, and third chambers filled with water to be split into hydrogen gas and oxygen gas;
a first baffle dividing the first chamber from the second chamber, the first baffle including an upper solid portion and a lower portion allowing fluid communication between the first and second chambers, the upper solid portion being formed from thermoplastic material and including at least one support member projecting into the second chamber;
a second baffle dividing the first chamber from the third chamber, the second baffle including an upper solid portion and a lower portion allowing fluid communication between the first and third chambers, the upper solid portion being formed from thermoplastic material and including at least one support member projecting into the third chamber;
a U-shaped first electrode disposed in the first chamber and configured to be at least partially immersed in the water;
a second electrode disposed in the second chamber and configured to be at least partially immersed in the water; and
a third electrode disposed in the third chamber and configured to be at least partially immersed in the water,
wherein the lower portion of the first and second baffles, the first electrode, the second electrode, and the third electrode each include mesh screen material consisting of a single metallic material, the mesh screen material defining about 30-60 wires and openings per inch of mesh screen material,
wherein the mesh screen material at the second and third electrodes includes a periphery and is frayed about the entire periphery so as to provide a plurality of wire fingers extending away from the mesh screen material, the wire fingers engaging the at least one support member to position the second and third electrodes in a desired position within the second and third chambers,
wherein when the electrolysis system is coupled to a current source, the first, second, and third electrodes become electrically charged so as to split the water into a hydrogen gas and an oxygen gas, the plurality of wire fingers oriented to project away from the remainder of the mesh screen material to provide escape paths for hydrogen or oxygen gas bubbles formed at the second and third electrodes, and
wherein the hydrogen gas and the oxygen gas supplements the combustion of gasoline in the internal combustion engine.

2. An electrolysis system adapted to split water into hydrogen and oxygen gases, the system comprising:
a housing;
a first baffle dividing the housing into a first chamber and a second chamber, the first baffle including an upper solid portion and a lower portion allowing fluid communication between the first and second chambers;
a first electrode disposed in the first chamber and configured to be at least partially immersed in the water; and
a second electrode disposed in the second chamber and configured to be at least partially immersed in the water,
wherein the lower portion of the first baffle, the first electrode, and the second electrode are each formed from the same material, and
wherein when the electrolysis system is coupled to a current source, the first and second electrodes become electrically charged so as to split the water into hydrogen and oxygen gases.

3. The electrolysis system of claim 2, further comprising:
a horizontal barrier wall dividing the housing into an upper compartment and a lower compartment, the upper compartment containing an inlet port adapted to deliver water from outside the housing to the lower compartment, the lower compartment containing the first baffle and the first and second chambers,
wherein the upper and lower compartments are fluidly isolated from each other.

4. The electrolysis system of claim 3, further comprising:
a first fastener member coupling the first electrode to the horizontal barrier wall;
a second fastener member coupling the second electrode to the horizontal barrier wall;
a positive lead wire coupled to the first fastener member; and
a negative lead wire coupled to the second fastener member,
wherein the positive lead wire and negative lead wire are configured to be connected to the current source.

5. The electrolysis system of claim 4, further comprising:
an outlet port configured to be operatively connected to a combustion chamber of an internal combustion engine,
wherein the positive lead wire and the negative lead wire are configured to be connected to a vehicle's electrical supply.

6. The electrolysis system of claim 2, wherein the lower portion of the first baffle and the first and second electrodes each comprise a mesh screen material.

7. The electrolysis system of claim 6, wherein the mesh screen material forming the lower portion of the first baffle and the first and second electrodes is formed from stainless steel.

8. The electrolysis system of claim 6, wherein the second electrode comprises a plurality of wire fingers extending away from the mesh screen material.

9. The electrolysis system of claim 8, wherein the second electrode further comprises a perimeter edge, and the plurality of wire fingers comprises frayed ends of the mesh screen material along the perimeter edge.

10. The electrolysis system of claim 2, further comprising:
a second baffle defining a third chamber, the second baffle including an upper solid portion and a lower portion allowing fluid communication between the first and third chambers; and
a third electrode disposed in the third chamber and configured to be at least partially immersed in the water,
wherein the lower portion of the second baffle and the first, second, and third electrodes are each formed from the same material.

11. The electrolysis system of claim 10, further comprising:
at least one outlet port configured to be operatively connected to a combustion chamber of an internal combustion engine,
wherein the at least one outlet port comprises an oxygen port in fluid communication with the first chamber and a hydrogen port in fluid communication with the second and third chambers.

12. The electrolysis system of claim 10, further comprising:
at least one outlet port configured to be operatively connected to a combustion chamber of an internal combustion engine,
wherein the at least one outlet port comprises a combined port in fluid communication with the first, second, and third chambers.

13. An electrolysis system adapted to split water into hydrogen and oxygen gases, the system comprising:
a housing;
a baffle dividing the housing into a first chamber and a second chamber, the baffle including a solid portion and a lower portion allowing fluid communication between the first and second chambers, the solid portion including at least one support member projecting into the second chamber;
a first electrode disposed in the first chamber and configured to be at least partially immersed in the water; and
a second electrode disposed in the second chamber and configured to be at least partially immersed in the water, the second electrode comprising mesh screen material having a periphery and being frayed about the entire periphery so as to provide a plurality of wire fingers extending away from the mesh screen material, the wire fingers engaging the at least one support member to support the second electrode in position within the second chamber,
wherein when the electrolysis system is coupled to a current source, the first and second electrodes become electrically charged so as to split the water into hydrogen and oxygen gases, the plurality of wire fingers oriented to project away from the remainder of the mesh screen material to provide escape paths for hydrogen or oxygen gas bubbles formed at the second electrode.

14. The electrolysis system of claim 13, wherein the second electrode further comprises a perimeter edge, and the plurality of wire fingers comprises frayed ends of the mesh screen material along the perimeter edge.

15. The electrolysis system of claim 14, wherein the mesh screen material forming the second electrode is formed from stainless steel.

16. The electrolysis system of claim 13, further comprising:
a horizontal barrier wall dividing the housing into an upper compartment and a lower compartment, the upper compartment containing an inlet port adapted to deliver water from outside the housing to the lower compartment, the lower compartment containing the baffle and the first and second chambers,
wherein the upper and lower compartments are fluidly isolated from each other.

17. The electrolysis system of claim 16, further comprising:
a first fastener member coupling the first electrode to the horizontal barrier wall;
a second fastener member coupling the second electrode to the horizontal barrier wall;
a positive lead wire coupled to the first fastener member; and
a negative lead wire coupled to the second fastener member,
wherein the positive lead wire and negative lead wire are configured to be connected to the current source.

18. The electrolysis system of claim 17, further comprising:
an outlet port configured to be operatively connected to a combustion chamber of an internal combustion engine,
wherein the positive lead wire and the negative lead wire are configured to be connected to a vehicle's electrical supply.

19. The electrolysis system of claim 13, wherein the lower portion of the baffle, the first electrode, and the second electrode each include mesh screen material consisting of nickel, the mesh screen material defining about 30-60 wires and openings per inch of mesh screen material.

20. The electrolysis system of claim 13, wherein the lower portion of the baffle, the first electrode, and the second electrode each include mesh screen material consisting of stainless steel, the mesh screen material defining about 30-60 wires and openings per inch of mesh screen material.
